(19) United States
(12) Patent Application Publication
(10) Pub. No.: US 2013/0197134 A1
(43) Pub. Date: Aug. 1, 2013

(54) COMPOSITIONS OF WARM MIX ASPHALT, PROCESS FOR THE SAME, USE THEREOF IN SURFACES

(71) Applicants: José Fernando Leal, Sao Paulo (BR); Jasmim Leal, Carapicuiba (BR)

(72) Inventors: José Fernando Leal, Sao Paulo (BR); Jasmim Leal, Carapicuiba (BR)

(73) Assignee: Quimigel Indústria E Comércio Ltda., Taboão da Serra SP (BR)

(21) Appl. No.: 13/876,052

(22) PCT Filed: Apr. 13, 2011
(86) PCT No.: PCT/BR11/00105

§ 371 Date: Mar. 26, 2013

(51) Int. Cl. C08L 95/00

(52) U.S. Cl. CPC C08L 95/00
USPC 524/69

(57) ABSTRACT

The present invention relates to use of organic chemical additives for the preparation of warm asphalt mixtures. The compositions of asphalt mixtures in accordance with the present invention provides a manufacturing, spreading and compaction lower temperatures up to 70° C. compared to the temperatures used in the production and application of conventional hot mix asphalt used in paving and road asphalt concrete overlays.

### FIELD OF THE INVENTION

The present invention relates to compositions of warm asphalt mixtures, characterized by production, spreading and compaction lower temperatures up to 70° C. in the temperatures used in the production and use of conventional hot asphalt mixes. The present invention relates specifically to compositions of asphalt mixtures containing organic chemical additives, aggregates and asphalt binder, which can be used in construction or maintenance of highways, roads, sidewalks, parking lots, airport runways and service roads and any other rolling surfaces.

### BACKGROUND OF THE INVENTION

The hot asphalt mixtures are produced by heating and mixing of mineral aggregates with asphalt binders. During mixing, the hot asphalt binder should be easily able to coat the dried and heated mineral aggregate in order to obtain a good coating film, compression and mechanical strength of the mixture during its application and service time.

Although the mixing and compaction temperatures should be high enough to enable rapid and uniform distribution of asphalt binder on the mineral aggregate surface, the use of temperatures as low as possible is desired in order to prevent an excessive oxidation of the asphalt binder and its consequent early aging.

Moreover, during the spreading and compaction, the hot asphalt mixtures usually release fumes that could contain toxic substances, which can directly impact on the health of workers involved in the application of the asphalt mixtures and cause damages to the environment.

In another aspect, the heating of aggregates and asphalt binder during hot production process influences drastically in the energy expenditure. For proper heating of aggregates and asphalt binder large amounts of energy is usually demanded, which has its sources coming in most cases from the burning of fossil fuels, creating greenhouse gases like carbon monoxide and carbon dioxide, contributing further to aggravate the consequences of the greenhouse effect.

During the recent years, various technologies trying to reduce the temperatures of manufacturing and application of hot asphalt mixtures have been proposed. These processes employ various mechanical methods and equipment modifications to reduce production and compaction temperatures of hot asphalt mixtures.

The warm mix asphalt differ from other asphalt mixtures in the temperatures in which they are produced and the strength and durability of the final product. The cold asphalt mixes using asphalt emulsions are performed at room temperature, between 10 and 50° C., while the hot asphalt mixtures are produced at temperatures between 160 and 190° C. The warm asphalt mixes are produced at temperatures between 90 to 135° C.

Recently, several developments in the manufacture of warm mix asphalt have been reported. Examples of these processes are: the use of two different types of asphalt during the manufacturing (as in WO 97/20890), introduction of a fraction of cold and wet mineral aggregates during the mixing stage to create a foamed liquid asphalt (as in EP 1 469 038 and EP 1 712 680), or use of an asphalt emulsion to also produce foam during mixing in order to achieve the total aggregate coating (as in WO 2007/112335). These processes have several advantages, including the reduction of energy consumption and emissions of pollutants, but require substantial modifications of the manufacturing plants and/or mixing equipment.

It is also described in the Brazilian patent BRPI0900455 method for preparation of warm mix asphalt without the use of chemical additives, only with the addition of small amount of additional aggregates to the asphalt mix, providing a range of temperature lower than the commonly used and this is possible due to the fact that the water in this additional small fraction of aggregates is heated during mixing and turns to steam, creating the effect of foaming on the asphalt, which reduces its viscosity, thus facilitating the coating of the aggregates and the subsequent mix compaction in low temperatures, around 110° C. to 120° C.

The presence of one or more organic chemical additives into the asphalt can increase the aggregate coating by asphalt binder and improve the workability of the asphalt mix during spreading and compaction even at temperatures up to 70° C. below the conventionally used in the production and application of the hot asphalt mixtures.

It's widely known that polymers can be added to the asphalt binder in order to obtain asphalt mixtures with better mechanical properties. Among the mechanical properties of asphalt binders, can be highlighted resistance to wheel tracks, fatigue resistance and crack resistance. Polymers are large molecules formed by chemical bonds of many repeating units chemically known as monomers. In general, conventional asphalt binders do not have at the same time all the ideal qualities and the addition of polymers to these asphalt binders allows favorably changes in their mechanical properties, forming modified polymers asphalt compositions that have improved mechanical properties compared to unmodified asphalt binders.

Therefore, the addition of polymers to asphalt binders is often performed to increase their flexibility and can also increase the cohesion and elastic recovery of asphalt at high temperatures of application. Examples of polymers commonly used in asphalt modification are: styrene butadiene rubbers, block copolymers of styrene butadiene, copolymers of ethylene vinyl acetate, polyethylene, alpha-polyolefins, olefin polymers functionalized by epoxy or carboxylic groups and also mixes among them.

The use of polymer modified asphalt for the manufacturing of asphalt mixtures often results in changes in their production process. During the manufacturing of hot asphalt mixtures, higher temperatures for the production, spreading and compaction are required when using a polymer modified asphalt. Moreover, the polymer modified asphalt may have higher viscosities compared to the unmodified asphalt even at high temperatures, which can also bring problems to the application of hot asphalt mixtures, reducing its workability.

It is of great interest that the modification of asphalt by a polymeric material could be done without increasing its manufacturing temperatures, compared to the standard asphalt, but still getting an improvement in the mechanical properties of the resulting asphalt mixture.

Moreover, a simultaneous decrease in temperature during the dispersion of the polymer into the asphalt and also during the manufacturing process of asphalt mixtures is of great value because it leads to several advantages. The decrease in temperature and/or dispersion time of polymers into the asphalt reduces oxidation and aging of asphalt binder, extending its lifetime in the final application, such as in an asphalt mix for paving a highway. Consequently, this reduction of temperature in the manufacturing process of polymer modified asphalt as well as in hot asphalt mixtures, reduce the amount of energy consumption during the dispersion and, more importantly, during the manufacturing process of asphalt mixtures. The reduction of energy consumption in the manufacturing process of asphalt mixtures also significantly reduces the amount of polluting emissions, including CO₂ and other greenhouse gases.

### OBJECT OF INVENTION

It is an object of this invention to provide the preparation of a composition of warm asphalt mixtures comprising at least the use of an organic chemical additive capable of increase the coating of asphalt binder on the aggregates surface decreasing the surface tension and increasing the effect of lubricity of the asphalt binder. Both combined effects increase the workability of asphalt mixtures at temperatures up to 70° C. below those normally used in conventional hot mix asphalt.

### SUMMARY OF THE INVENTION

The present invention relates to compositions of warm asphalt mixtures, resulting in manufacturing, spreading and compaction temperatures up to 70° C. lower compared to the temperatures used in the production and application of conventional asphalt mixtures.

The compositions of warm asphalt mixtures described in this invention have the advantage of decreasing the temperature in the production, spreading and compaction of asphalt mixtures, which can contribute positively in many aspects, including economic, environmental and occupational, among them:
reductions of greenhouse gases emissions due to reduction in the burning rates of fossil fuels;
reducing the emission of toxic gases and as a consequence, reduction of occupational exposure of workers;
reduction of energy consumption and consequent savings in the process;
reduction of excessive oxidation of the asphalt binder and consequent reduction in premature aging of the asphalt binder;
increasing the mixing equipment productivity in up to 20% compared to productivity achieved by hot temperatures mixing processes due to reduction in working temperatures;
optimizing the transport of asphalt mixtures from the plant to the application site, allowing greater distances between the plant mix and warm mix asphalt application sites.

The present invention relates also to the process to obtain the compositions of warm asphalt mixes and the use thereof in surfaces.

The invention presented do not necessarily requires any other chemicals such as polymers, catalysts, fluxing agents or crosslinking agents to achieve the reduction of manufacturing, spreading and compaction temperatures of asphalt mixtures, although some of these products may be added, as well as other conventional additives, according to the job mix design or for improving the rheological properties and physical-chemical properties of the asphalt supplied by conventional refineries.

### DETAILED DESCRIPTION OF THE INVENTION

The present invention relates to compositions of warm asphalt mixes, resulting in manufacturing, spreading and compacting temperatures up to 70° C. lower compared to the temperatures used in the production of conventional asphalt mixtures.

The compositions of the present invention comprise asphalt mixtures with aggregates, asphalt binders and organic chemical additives. The fine aggregates have particle sizes between 0.075 mm to 2.0 mm and the coarse aggregates have dimensions greater than 2.0 mm. The fine and coarse aggregates can be matched for getting different graduation types, for example dense or open, uniform or discontinuous. It also can be added to the asphalt mix filler material and/or sand.

Asphalt or asphalt binder is manufactured during the distillation and refining petroleum process as a bottom column product. Due to different origins and processes of petroleum refining and distillation, the resulting asphalt can have a wide range of properties and characteristics. In the present invention, the term asphalt does not only refer to the petroleum product obtained by direct distillation or by distillation at low pressures, particularly known as asphalt cement, but also the product coming from the extraction of tar and bituminous sands, synthetic asphalt, tar, petroleum resins and/or paraffinic hydrocarbons and mixtures among them.

The conventional manufacturing, spreading and compacting temperatures of hot asphalt mixtures are considered between 160° C. to 190° C.

The composition of the organic chemical additives of the present invention promotes the changing of surface tension as well as the increase of the lubricity effect of asphalt binder, allowing an ideal coating of the aggregates by the asphalt binder and promoting optimum workability of the asphalt mixture at temperatures up to 70° C. below those conventionally used in manufacturing, spreading and compaction of asphalt mixtures, more specifically between the temperatures of 90° C. to 135° C.

The compositions of the present invention comprise asphalt mixtures containing at least, but not restrictive:

(i) 92% to 97% by weight of coarse and fine aggregates;

(ii) 3% to 8% by weight of asphalt binder;

(iii) 0.0001% to 0.5% by weight of one or more organic chemical additives.

In the compositions here described, the organic chemical additives promotes an efficient aggregates mixing and coating process by the asphalt binder at temperatures up to 70° C. lower than those usually used in the process of hot asphalt mixtures.

The present invention can be used in the asphalt plants gravimetric or volumetric types, without any change in their structure and/or flow of materials. The addition of a chemical organic additive(s) may be carried before, after or simultaneously with other necessary or even desirable components to modify the asphalt binder, such as polymers, catalysts or fluxing agents.

The contents of one or more organic chemical additives should be added in the range from 0.0001% to 0.5% based on total weight of the asphalt mixture, preferably from 0.01% to 0.05% based on total weight of asphalt in the mixture.

Preferably, the compositions of warm asphalt mixtures described in this invention comprise at least one organic chemical additive, which is the result of reaction between:

(i) a functional group among the compounds (1) to (4) or mixture thereof:

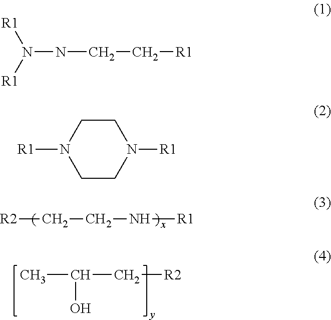

wherein

R1 represents H, CH₃, OH, CH₂CH₂OH, CH₂CH₂NH₂, CH₂CH₃, OCH₂CH₂OH or NHCH₂CH₂OH;

R2 represents N, NH ou NH₂;

x=0 to 4;

y=1 to 3;

(ii) at least one fatty acid or mixture of fatty acids and/or an fatty acid ester and/or fatty acid chloride;

(iii) a functional group among the compounds (5) to (10) or mixture thereof:

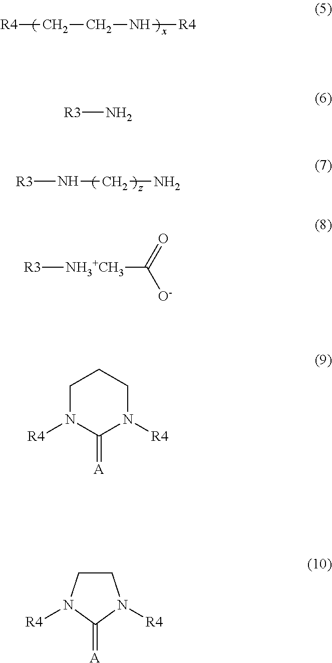

wherein:

x=0 to 4;

z=1 to 7;

A represents oxygen, sulfur or NH, preferably oxygen;

R3 represents a fatty radical;

R4 represents a group containing a primary amine, secondary amine, amide, a hydrocarbon group preferably a linear or branched substituted or substituted alkyl chain, a hydroxyl functional group or hydrogen.

Certain molecules having at least one functional group from (1) to (4) correspond, but not as a restricted form, to N,N-diethylethanolamine (DEEA), N,N-dimethylethanolamine (DMEA), N-methyldiethanolamine (MDEA), N-methylethanolamine (NMEA).

Examples of fatty acids that may be used for this reaction are the saturated or unsaturated carboxylic acids with at least 5 carbon atoms, such as linear monoacids like lauric, mystiric, oleic, stearic, linoleic or linolenic acids, branched monoacids like 2-ethyl hexanoic acid, linear diacids such as glutaric, adipic, pimelic, suberic, azelaic, sebacic, undecanedioic, dodecanediodic, brassylic, tetradecanedioic, pentadecanedioic, thapsic, or octadecanedioic acids, branched diacids like 3,3-dimethylglutaric acid and undecylenic, myristoleic, palmitoleic, oleic, linoleic, linolenic, ricinoleic, eicosenoic or docosenoic acids (found on pine, corn, sunflower, soybean, raisin seeds, linen or jojoba) or animal origin like eicosapentaenoic or docosahexaenoic acids (found in fish oils).

Non-restrictive examples of molecules containing at least one functional group from (5) to (10) are primary amines, diamines, polyamines, amides.

The reaction of fatty acids with alkyl amines, amines, amino alcohols or amidoamines results in soap surfactants (for example N,N-diethyl ethanol ammonium stearate). At higher temperatures, secondary alkyl alkanolamines (for example N-methylethanolamine) react with fatty acids in equimolar proportions, resulting in amide, also with significant amounts of amine ester and amide. Tertiary alkyl alkanolamines results in amine esters only.

In one aspect, this invention relates to the process for preparing a composition of warm asphalt mixtures comprising at least the use of an organic chemical additive capable of increasing the coating of asphalt binder to the aggregates through the change of surface tension, as well as increase the effect of lubricity of asphalt binder and thereby increase the workability of asphalt mixtures, comprising the following steps:

(i) addition to the asphalt in solid, molten, dissolved or dispersed state of one or more organic chemical additives capable to produce, manufacture, spread and compact asphalt mixtures at temperatures lower than the values that are regularly applied in each of these processes;

(ii) Optionally, add one or more components in the asphalt, such as those described here earlier, where the order of addition between them and those organic chemical additives or mixture of those is irrelevant;

(iii) Mix the components of steps (i) and (ii), preferably under mild agitation, by any mechanical process during a period of time sufficient to obtain a homogeneous mixture, and this period of time usually varies from 1 minute to several hours, normally from 1 to 60 minutes, with temperatures between 120° C. to 190° C.;

(iv) Machine the obtained homogeneous mixture with aggregates in temperatures between 110° C. to 135° C.; and

(v) Obtain a warm asphalt mixture ready for use in the spreading and compaction temperature range between 90° C. to 135° C.

One or more organic chemical additives in accordance with the present invention can be added to a continuous flow of the asphalt by any types of continuous process, for example, using a direct injection and/or a static mixer in the production process of warm mix asphalt.

According to another aspect, this invention relates to a formulation comprising at least among one or more of the organic chemical additives such as described above, and at least one or more components chosen from the adhesion promoters agents, polymers, acid adjuvants, crosslinking agents, fluxing agents, additives reagents, talc, carbon black and used scrap tires powder.

Not limitative examples of polymers conventionally used are: styrene butadiene rubbers, block copolymers of styrene butadiene styrene (SBS), copolymers of ethylene vinyl acetate, polyethylene, alpha-polyolefins, olefin polymers functionalized by epoxy or carboxyl (COOH) groups such as terpolymers of ethylene/alkyl acrylate/glycidyl methacrylate, terpolymers of ethylene/n-butyl acrylate/glycidyl methacrylate, copolymers of ethylene alkyl acrylate and/or mixtures thereof for modifying the asphalt binder to be used in warm asphalt mixture. The polymer composition according to the present invention can be present in the asphalt in any quantity sufficient to achieve improvements in mechanical properties of asphalt binders and/or asphalt mixture, preferably in amounts of about 0.001 wt % to about 25 wt %, based on the asphalt mixture.

Non limiting examples of the acid adjuvants are inorganic acids such as phosphoric acid, polyphosphoric acids, superphosphoric acid, sulfuric acid, hydrochloric acid, nitric acid, boric acid, phosphonic acids, anhydrides of these acids and mixtures thereof. In a non limiting embodiment, the proportion of acid adjuvants are preferably between 0.05 wt % to 2 wt % based on total asphalt binder.

Among the crosslinking agents may be highlighted, mainly, but non restrictive, elemental sulfur, a sulfur donor agent, such as ditiodi morpholine, thiuram disulfide, zinc, or any compound with two or more sulfur atoms bound to each other.

Among the fluxing agents mentioned above, may be highlighted in a non-restrictive way, epoxidized fatty acids from vegetable or animal sources; esterified fatty acids of vegetable or animal sources, petroleum cuts with aromatic character, naphthenic-aromatic, naphthenic-paraffinic and paraffinic.

Among the additive reagents it could be highlighted in a non-restrictive way, more specifically, primary amines, secondary amines, diamines or polyamines.

The main application for the compositions of asphalt mixtures presented in this invention, but not restricted, is the construction or maintenance of highways, roads, sidewalks, parking lots, airport runways, service roads, waterproof membranes, aged asphalt mixtures recycling and any other bearing surfaces.

Thus, and in accordance with another aspect, the invention relates to a surface that is coated in whole or in part with a composition of asphalt mixture and, as described above, said surface is generally a rolling surface, such as roads, parking lots, bridges, roads, highways, airport runways or any similar rolling surface, and also any surface requiring asphalt coating or asphalt, such as walks, sidewalks, parks, roofs, walls and similar.

The mineral aggregate used in the compositions of warm asphalt mixtures of the present invention are not limited in its chemical nature, shape or size and may be the products of quarries, recovered aggregates from the previous asphalt mixtures, milled or recycled asphalt, construction products and mixture of any of the above.

The compositions of warm asphalt mixtures in accordance with the present invention may contain other common components of asphalt mixtures such as organic fibers (for example cellulose, cotton, polypropylene, polyester, polyvinyl alcohol, and polyamide fibers) and inorganic fibers (for example: glass, metal or carbon fibers), filler material and/or sand.

The present invention also provides several advantages for manufacturing, spreading and compaction of asphalt mixtures produced with polymer modified asphalt. In the conventional hot asphalt mixtures produced with polymer modified asphalt, there is a considerable increase in viscosity after manufacture. This increase in viscosity leads to a difficult or incomplete coverage of the mineral aggregates by polymer modified asphalt. Furthermore, the increase in viscosity also has a negative impact on the spreading and compaction of the conventional asphalt mix. Warm asphalt mixtures made according to the present invention will not experience any particular problem related to an increase in viscosity, since they have a better flow than the conventional hot mix asphalt, neither to the incomplete aggregate coating and the workability of asphalt mixtures, as these properties are improved in this invention.

The decrease in manufacturing, machining, spreading and compaction temperatures using the compositions of warm asphalt mixtures of the present invention has as a consequence the decreasing of the energy consumed in these processes, as well as a decrease in the oxidation process of the asphalt binder. Moreover, this reduction of energy also implies a reduction in emissions of CO₂ and other greenhouse gases.

Another advantage of this invention when used to produce an asphalt mix is its easiness of recycling compared with conventional hot mix asphalt, for once reheated the asphalt mixture comprising the composition of the present invention, since it has a better flow at lower temperatures, improving the handling, mixing, spreading and compaction of these warm recycled asphalt mixtures.

Below are described Examples of application of the present invention, non-limiting, in an only illustrative character:

### Example 1

It was prepared an asphalt mixture in accordance with the present invention, comprising the steps:

1. The asphalt cement (CAP 50/70) was heated to 160° C. in the industrial mixing tank and then was added the organic chemical additive GEMUL® XT-14, commercially provided by the same applicant of this invention patent.

2. It was dispersed a terpolymer of acrylic ester, ethylene and glycidyl methacrylate in the mixture previously prepared.

3. The mixture was subjected to mechanical stirring for 2 hours under the temperature of 160° C.

4. Polyphosphoric acid 116% was added and the mixture maintained at mechanical stirring for 30 minutes.

5. The mineral aggregates, sand and lime were dried and heated to a temperature of 140° C.

6. Proceed the manufacturing stage of the asphalt mixture, where mineral aggregates, sand, lime and asphalt binder previously prepared in steps 1 to 4 were then mixed in a “pugmill” (mixing box) under the temperature of 130° C., promoting the coating of mineral aggregates by the asphalt binder. In this step a thick layer of asphalt binder involves the mineral aggregates.

7. A final homogeneous asphalt mixture was obtained.

8. The asphalt mixture produced was transported/spread and compacted in the temperature between 120° C. to 130° C. and 90° C. to 100° C., respectively.

In Table I is described the composition of the warm mix asphalt produced:

TABLE I
warm asphalt mixture composition produced

| | | Composition |
|---|---|---|
| Num. | Material | (by % weight) |
| 1 | CAP 50/70 | 4.8885 |
| 2 | GEMUL ® XT-14 | 0.0200 |
| 3 | Polymer | 0.0800 |
| 4 | Polyphosphoric acid 116% | 0.0115 |
| 5 | Coarse aggregates ¾ | 23.7500 |
| 6 | Fine aggregates | 22.8000 |
| 7 | Ultra fine aggregates | 37.5250 |
| 8 | Medium sand | 9.5000 |
| 9 | Hydrated limestone CH-1 | 1.4250 |

In Table II is detailed the range of granulometry of the mineral coarse and fine aggregates and filler in percentages, based on the total dry weight of aggregates:

TABLE II
Range of granulometry of aggregates

| | | Coarse | Fine | Ultra fine | | Hydrated | |
|---|---|---|---|---|---|---|---|
| Sieve size | | aggregates ¾ | aggregates | aggregates | Sand | limestone CH-1 | |
| Inches | Milimeters | % Pass | | | | | Total |
| 1″ | 25.40 | 100.00 | 100.00 | 100.00 | 100.00 | 100.00 | 100.00 |
| ¾″ | 19.10 | 100.00 | 100.00 | 100.00 | 100.00 | 100.00 | 100.00 |
| ½″ | 12.70 | 57.30 | 100.00 | 100.00 | 100.00 | 100.00 | 89.33 |
| ⅜″ | 9.52 | 13.40 | 98.20 | 100.00 | 100.00 | 100.00 | 77.92 |
| n. ° 4 | 4.76 | 0.50 | 3.10 | 99.10 | 98.70 | 100.00 | 51.38 |
| n. ° 10 | 2.00 | 0.50 | 1.00 | 69.10 | 92.20 | 100.00 | 38.38 |
| n. ° 40 | 0.42 | 0.50 | 0.90 | 32.00 | 36.80 | 99.30 | 18.15 |
| n. ° 80 | 0.18 | 0.50 | 0.90 | 21.40 | 3.70 | 96.80 | 10.62 |
| n. ° 200 | 0.08 | 0.40 | 0.90 | 15.20 | 0.40 | 85.30 | 7.64 |

Asphalt mixture's specimens were prepared in laboratory, which were subjected to the tests described in Table III:

TABLE III
tests results of asphalt mixture's laboratorial specimens.

| Method | Result | |
|---|---|---|
| Asphalt binder content | 5.0% | |
| Specific gravity of asphalt binder produced | 1.014 | g/cm³ |
| in steps 1 to 4 at 25° C. | | |
| Theoretical maximum specific gravity | 2.639 | g/cm³ |
| Apparent specific gravity | 2.534 | g/cm³ |
| Air Voids (Va) | 3.97% | |
| Voids in the Mineral Aggregate (VMA) | 17.33% | |
| Voids Filled with Asphalt (VFA) | 77.09% | |
| Marshall Flow | 3.08 | mm |
| Marshall Stability | 1564.88 | Kgf |
| Tensile strength by diametral compression | 16.25 | Kg/cm² |

Table IV describes the tests performed on asphalt binder prepared in steps 1 to 4:

TABLE IV
tests results performed on the asphalt
binder prepared in steps 1 to 4

| Characteristic | Unity | Method | Result |
|---|---|---|---|
| Penetration (100 g, 5 s, 25° C.) | 0.1 mm | NBR 6576 | 52 |
| Softening Point, min. | ° C. | NBR 6560 | 57 |
| Brookfield Viscosity at 135° C., | cP | NBR 15184 | 1032 |
| SP 21, 20 rpm, max. | | | |
| Brookfield Viscosity at 150° C., | cP | NBR 15184 | 491 |
| SP 21, 50 rpm, max. | | | |
| Brookfield Viscosity at 177° C., | cP | NBR 15184 | 164 |
| SP 21, 100 rpm, max. | | | |
| Flash Point, min. | ° C. | NBR 11341 | >240 |
| Phase Separation, max. | ° C. | NBR 15166 | 1.5 |
| Elastic Recovery, 25° C., 20 cm, | % | NBR 15086 | 78 |
| min. | | | |

Tests in RTFOT Residue at 163° C., 85 minutes:

| | | | |
|---|---|---|---|
| Mass change, max. | % | ASTM D2872 | 0.39 |
| Softening Point Increase, max. | ° C. | NBR 6560 | 4.0 |
| Softening Point Decrease, max. | ° C. | NBR 6560 | — |
| Percent of the Original Penetration, | % | NBR 6576 | 70 |
| min. | | | |
| Percent of the Original Elastic | % | NBR 15086 | 86 |
| Recovery, min. | | | |

### Example 2

It was prepared an asphalt mixture in accordance with the present invention, comprising the steps:

1. The asphalt cement (CAP 30/45) was heated to 160° C. in the industrial mixing tank and then was added the organic chemical additive GEMUL® XT-14, commercially provided by the same applicant of this invention patent.

2. The mixture was subjected to mechanical stirring for 2 hours under the temperature of 160° C.

3. The mineral aggregates, sand and lime were dried and heated to a temperature of 140° C.

4. Proceed the manufacturing stage of the asphalt mixture, where mineral aggregates, sand, lime and asphalt binder previously prepared in steps 1 to 3 were then mixed in a “pugmill” (mixing box) under the temperature of 130° C., promoting the coating of mineral aggregates by the asphalt binder. In this step a thick layer of asphalt binder involves the mineral aggregates.

5. A final homogeneous asphalt mixture was obtained.

6. The asphalt mixture produced was transported/spread and compacted in the temperature between 120° C. to 130° C. and 90° C. to 100° C., respectively.

In Table V is described the composition of the warm mix asphalt produced:

TABLE V
warm asphalt mixture composition produced

| | | Composition |
|---|---|---|
| Num. | Material | (by % weight) |
| 1 | CAP 30/45 | 5.0847 |
| 2 | GEMUL ® XT-14 | 0.0153 |
| 5 | Coarse aggregates 1 | 13.286 |
| 6 | Fine aggregates | 42.705 |
| 7 | Ultra fine aggregates | 37.4855 |
| 9 | Hydrated limestone CH-1 | 1.4235 |

In Table VI is detailed the range of granulometry of the mineral coarse and fine aggregates in percentages, based on the total dry weight of aggregates:

TABLE VI
Range of granulometry of aggregates

| Sieve size | | |
|---|---|---|
| Inches | Milimeters | % Pass |
| 1″ | 25.40 | 100.00 |
| ¾″ | 19.10 | 100.00 |
| ½″ | 12.70 | 91.62 |
| ⅜″ | 9.52 | 85.19 |
| n.° 4 | 4.76 | 50.40 |
| n.° 10 | 2.00 | 32.14 |
| n.° 40 | 0.42 | 16.60 |
| n.° 80 | 0.18 | 10.73 |
| n.° 200 | 0.08 | 6.32 |

Asphalt mixture's specimens were prepared in laboratory, which were subjected to the tests described in Table VII:

TABLE VII
tests results of asphalt mixture's laboratorial specimens.

| Method | Result |
|---|---|
| Asphalt binder content | 5.1% |
| Specific gravity of asphalt binder produced | 1.050 g/cm³ |
| in steps 1 to 4 at 25° C. | |
| Theoretical maximum specific gravity | 2.484 g/cm³ |
| Apparent specific gravity | 2.374 g/cm³ |
| Air Voids (Va) | 4.8% |
| Voids in the Mineral Aggregate (VMA) | 16.5% |
| Tensile strength by diametral compression | 2.08 MPa |

Table VIII describes the tests performed on asphalt binder prepared in steps 1 to 3:

TABLE VIII
tests results performed on the asphalt
binder prepared in steps 1 to 3

| Characteristic | Unity | Method | Result |
|---|---|---|---|
| Penetration (100 g, 5 s, 25° C.) | 0.1 mm | NBR 6576 | 20 |
| Softening Point, min. | ° C. | NBR 6560 | 58.3 |
| Brookfield Viscosity at 135° C., | cP | NBR 15184 | 495 |
| SP 21, 20 rpm, max. | | | |
| Brookfield Viscosity at 150° C., | cP | NBR 15184 | 241 |
| SP 21, 50 rpm, max. | | | |
| Brookfield Viscosity at 177° C., | cP | NBR 15184 | 85 |
| SP 21, 100 rpm, max. | | | |

Tests in RTFOT Residue at 163° C., 85 minutes:

| | | | |
|---|---|---|---|
| Mass change, max. | % | ASTM D2872 | 0.9 |
| Softening Point Increase, max. | ° C. | NBR 6560 | 4.5 |
| Softening Point Decrease, max. | ° C. | NBR 6560 | — |
| Percent of the Original Penetration, | % | NBR 6576 | 71 |
| min. | | | |

1. A warm asphalt mix composition, comprising:
(i) content of coarse and fine aggregates in the range of 92% to 97% by weight based on total weight of the asphalt mix;
(ii) content of asphalt binders modified by organic and/or inorganic polymers in the range of 3% to 8% by weight based on total weight of the asphalt mix;
(iii) content of at least one or more organic chemical additives in the range of 0.0001% to 0.5% by weight based on total weight of the asphalt mix, wherein the organic chemical additives are composed by:
(a) a reaction result between one of the compounds among (1) to (2) or a mixture thereof and at least one fatty acid or mixture of fatty acids: 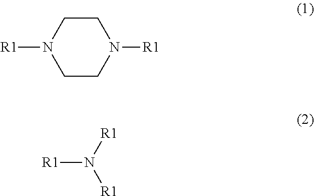
wherein
R1 represents H, H₂, CH₃, CH₂CH₃, (CH₂CH₂NH)ₓH, (CH₂CH₂OH)_{y} and/or CH₂CH₂NHCH₂CH₂OH;
x=1 to 10;
y=1 to 3; and
(b) one or more primary amines, secondary amines, tertiary amines, diamines, polyamines, quaternary ammonium compounds, amine acetates or a mixture thereof.

2. The warm asphalt mix composition of claim 1, wherein the fine aggregates have dimensions between 0.075 mm to 2.0 mm and the coarse aggregates have dimensions greater than 2.0 mm.

3. The warm asphalt mix composition of claim 2, additionally comprising one or more components selected from adhesion promoters agents, acid adjuvants, crosslinking agents, fluxing agents, additives reagents, talc, carbon black and used scrap tires powder.

4. A process for making a warm asphalt mix composition, the warm asphalt mix composition including:
(i) content of coarse and fine aggregates in the range of 92% to 97% by weight based on total weight of the asphalt mix;
(ii) content of asphalt binders modified by organic and/or inorganic polymers in the range of 3% to 8% by weight based on total weight of the asphalt mix;
(iii) content of at least one or more organic chemical additives in the range of 0.0001% to 0.5% by weight based on total weight of the asphalt mix, wherein the organic chemical additives are composed by:
(a) a reaction result between one of the compounds among (1) to (2) or a mixture thereof and at least one fatty acid or mixture of fatty acids: 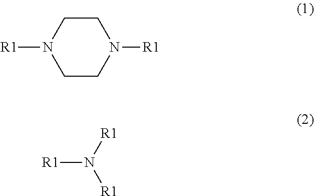
wherein
R1 represents H, H₂, CH₃, CH₂CH₃, (CH₂CH₂NH)ₓH, (CH₂CH₂OH)_{y} and/or CH₂CH₂NHCH₂CH₂OH;
x=1 to 10;
y=1 to 3; and
(b) one or more primary amines, secondary amines, tertiary amines, diamines, polyamines, quaternary ammonium compounds, amine acetates or a mixture thereof,
the process comprising the following steps:
(i) adding to the asphalt modified by organic and/or inorganic polymers in solid, molten, dissolved or dispersed state one or more organic chemical additives capable of producing, manufacturing, spreading and compacting asphalt mixtures at temperatures lower than 160° C.;
(ii) adding one or more components in the asphalt modified by organic and/or inorganic polymers, selected from adhesion promoters agents, acid adjuvants, crosslinking agents, fluxing agents, additives reagents, talc, carbon black and used scrap tires powder, where the order of addition between them and those organic chemical additives or mixture of those is irrelevant;
(iii) adding to the composition coarse and fine aggregates;
(iv) mixing, under mild agitation, by any mechanical process during a period of time sufficient to obtain a homogeneous mixture; and
(v) obtaining a warm mix asphalt ready for use.

5. The process of claim 4, wherein the step (iv) is conducted between 1 minute to several hours at temperatures ranging from 110° C. to 160° C.

6. The process of claim 4, wherein the step (v) includes providing a warm mix asphalt ready for use at spreading and compacting temperature range between 90° C. to 120° C.

7. The process of claim 4, wherein at least one organic chemical additive is added to a continuous flow of the asphalt by a continuous process in the manufacturing process of warm mix asphalt.

8. The process of claim 4, wherein the step (i) includes adding at least one organic chemical additives before, concomitantly or after manufacturing the asphalt mixture.

9. The process of claim 4, further comprising using the warm mix asphalt composition in construction or maintenance of highways, roads, sidewalks, parking lots, bridges, airport runways, sidewalks, parks, roofs, walls, service roads, waterproof membranes, asphalt recycling and any other bearing surfaces.

10. A surface coated in whole or in part with a warm asphalt mix composition, the warm asphalt mix composition comprising:
(i) content of coarse and fine aggregates in the range of 92% to 97% by weight based on total weight of the asphalt mix;
(ii) content of asphalt binders modified by organic and/or inorganic polymers in the range of 3% to 8% by weight based on total weight of the asphalt mix;
(iii) content of at least one or more organic chemical additives in the range of 0.0001% to 0.5% by weight based on total weight of the asphalt mix, wherein the organic chemical additives are composed by:
(a) a reaction result between one of the compounds among (1) to (2) or a mixture thereof and at least one fatty acid or mixture of fatty acids: 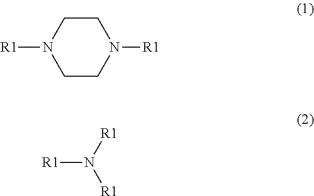
wherein
R1 represents H, H₂, CH₃, CH₂CH₃, (CH₂CH₂NH)ₓH, (CH₂CH₂OH)_{y} and/or CH₂CH₂NHCH₂CH₂OH;
x=1 to 10;
y=1 to 3; and
(b) one or more primary amines, secondary amines, tertiary amines, diamines, polyamines, quaternary ammonium compounds, amine acetates or a mixture thereof.

11. The surface of claim 10, wherein the surface is a bearing surface.

12. The warm asphalt mix compositions of claim 1, wherein the fatty acids in the iii (a) are saturated or unsaturated carboxylic acids with at least 5 carbon atoms.

13. The process of claim 4, wherein in the step (i) the production manufacturing, spreading and compacting temperatures occurs between the temperatures of 90° C. to 135° C.

14. The warm asphalt mix compositions of claim 1, wherein the asphalt binders modified by organic and/or inorganic polymers include at least one polymer selected from the group consisting of styrene butadiene rubbers, block copolymers of styrene butadiene styrene (SBS), copolymers of ethylene vinyl acetate, polyethylene, alpha-polyolefins, olefin polymers functionalized by epoxy or carboxyl (COOH) groups, terpolymers of ethylene/alkyl acrylate/glycidyl methacrylate, terpolymers of ethylene/n-butyl acrylate/glycidyl methacrylate, copolymers of ethylene alkyl acrylate, polyphosphoric acids and superphosphoric acids.

15. The warm asphalt mix composition of claim 1, additionally comprising one or more components selected from adhesion promoters agents, acid adjuvants, crosslinking agents, fluxing agents, additives reagents, talc, carbon black and used scrap tires powder.

16. The process of claim 5, wherein the step (iv) is conducted between 1 to 60 minutes.

17. The process of claim 7, wherein the continuous process uses direct injection or a static mixer.

18. The warm asphalt mix of claim 12, wherein the saturated or unsaturated carboxylic acids with at least 5 carbon atoms are selected from the group consisting of linear monoacids including lauric, mystiric, oleic, stearic, linoleic or linolenic acids, branched monoacids including 2-ethyl hexanoic acid, linear diacids including glutaric, adipic, pimelic, suberic, azelaic, sebacic, undecanedioic, dodecanediodic, brassylic, tetradecanedioic, pentadecanedioic, thapsic, or octadecanedioic acids, branched diacids including 3,3-dimethylglutaric acid and undecylenic, myristoleic, patmitoleic, oleic, linoleic, linolenic, ricinoleic, eicosenoic or docosenoic acids (found on pine, corn, sunflower, soybean, raisin seeds, linen or jojoba) and animal origin like eicosapentaenoic or docosahexaenoic acids (found in fish oils).
